(19) United States
(12) Patent Application Publication
(10) Pub. No.: US 2024/0397402 A1
(43) Pub. Date: Nov. 28, 2024

(54) FIRST BASE STATION DEVICE, SECOND BASE STATION DEVICE, REFLECTION CONTROL METHOD, AND WIRELESS COMMUNICATION SYSTEM

(71) Applicant: FUJITSU LIMITED, Kawasaki-shi Kanagawa (JP)

(72) Inventor: Tetsuya HASEGAWA, Setagaya (JP)

(73) Assignee: FUJITSU LIMITED, Kawasaki-shi Kanagawa (JP)

(21) Appl. No.: 18/795,316

(22) Filed: Aug. 6, 2024

Related U.S. Application Data
(63) Continuation of application No. PCT/JP2022/016536, filed on Mar. 31, 2022.

(51) Int. Cl. H04W 36/30

(52) U.S. Cl. CPC H04W 36/30

(57) ABSTRACT

A first base station device in a wireless communication system that includes: the first base station device configured to wirelessly connect to a first terminal device; and a second base station device configured to wirelessly connect to the first terminal device via a reflection device, in which the reflection device is controlled by the second base station device, to reflect a radio wave transmitted by the second base station device, and transmit a reflected wave, the first base station device including: a reception circuit configured to receive, from the first terminal device, a measurement result indicating radio quality of the reflected wave measured by the first terminal device, and control information obtained from the reflected wave by the first terminal; and a control circuit configured to transmit the control information to the second base station device, when the first terminal device performs a handover to the second base station device.

### CROSS-REFERENCE TO RELATED APPLICATION

This application is a continuation application of International Application PCT/JP2022/016536 filed on Mar. 31, 2022 and designated the U.S., the entire contents of which are incorporated herein by reference.

### FIELD

The embodiments discussed herein are related to a first base station device, a second base station device, a reflection control method, and a wireless communication system.

### BACKGROUND

In recent years, communication systems using wireless communication have been used. In a wireless communication system, wireless communication is performed by transmitting and receiving radio waves between a base station device and a terminal device, for example.

In a case where a shielding object such as a building is present in the communication area of a base station device, the base station device might not be able to transmit radio waves to a terminal device located in that communication area. In this case, the terminal device might not be able to wirelessly connect to the base station device, even when located in the communication area of the base station device. There are techniques for reflecting radio waves with a reflector that reflects radio waves in an area any radio waves do not reach in such a communication area.

Techniques related to a radio wave reflector are disclosed in the following documents.

International Publication Pamphlet No. WO 2020/189453 and Japanese National Publication of International Patent Application No. 2016-536931 are disclosed as related art.

However, there are cases where waves reflected by a reflector are controlled to track a specific terminal device, for example. In such a case, even if another terminal device receives reflected waves and attempts to wirelessly connect to the base station device that is the reflection source, the specific terminal device moves, and therefore, the another terminal device might become unable to receive the reflected waves. As a result, the another terminal devices might fail in wireless connection.

In view of this, one disclosure provides a first base station device, a second base station device, a reflection control method, and a wireless communication system that reduces failures in wireless connection to a base station device that is the transmission source of reflected waves in a communication system that uses waves reflected by a reflector.

### SUMMARY

According to an aspect of the embodiments, there is provided a first base station device in a wireless communication system that includes: the first base station device configured to wirelessly connect to a first terminal device; and a second base station device configured to wirelessly connect to the first terminal device via a reflection device, in which the reflection device is controlled by the second base station device, to reflect a radio wave transmitted by the second base station device, and transmit a reflected wave, the first base station device including: a reception circuit configured to receive, from the first terminal device, a measurement result indicating radio quality of the reflected wave measured by the first terminal device, and control information obtained from the reflected wave by the first terminal; and a control circuit configured to transmit the control information to the second base station device, when the first terminal device performs a handover to the second base station device.

The object and advantages of the disclosure will be realized and attained by means of the elements and combinations particularly pointed out in the claims.

It is to be understood that both the foregoing general description and the following detailed description are exemplary and explanatory and are not restrictive of the disclosure.

### BRIEF DESCRIPTION OF DRAWINGS

FIG. 1 is a diagram illustrating an example configuration of a wireless communication system 10;

FIG. 2 is a diagram illustrating an example configuration of a base station device 200;

FIG. 3 is a diagram illustrating an example configuration of a terminal device 100;

FIG. 4 is a diagram illustrating an example configuration of a reflection device 300;

FIG. 5 is a diagram illustrating an example of a process in which a terminal device 100-2 performs a handover to a base station device 200-1;

FIG. 6 is a diagram illustrating an example of a sequence in which the terminal device 100-2 performs a handover to the base station device 200-1;

FIG. 7 is a diagram illustrating an example of the reflected waves at the time of execution of reflection control on the terminal device 100-2;

FIG. 8 is a diagram illustrating an example configuration of a wireless communication system 10; and

FIG. 9 is a diagram illustrating an example of a sequence in which the terminal device 100-2 performs a handover to the base station device 200-1.

### DESCRIPTION OF EMBODIMENTS

### First Embodiment

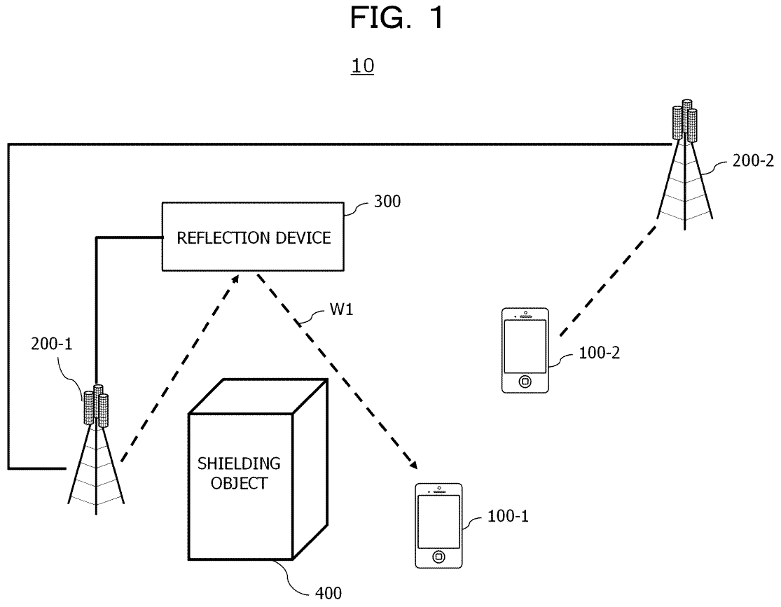

A first embodiment is described. FIG. 1 is a diagram illustrating an example configuration of a wireless communication system 10. The wireless communication system 10 includes a reflection device 300, terminal devices 100-1 and -2, and base station devices 200-1 and -2. Further, in the wireless communication system 10, a shielding object 400 exists in the communication area of the base station device 200-1.

Each of the base station devices 200-1 and -2 (hereinafter also referred to as the base station devices 200 in some cases) has a communication area. The base station devices 200 wirelessly connect to and communicate with the terminal devices 100-1 and -2 in the communication areas. Furthermore, the base station devices 200 each have a directional antenna, and can control the direction of transmission of radio waves by changing the multilevel modulation scheme or using the directional antenna.

The terminal devices 100-1 and -2 (hereinafter also referred to as the terminal devices 100 in some cases) are communication devices that wirelessly connect to the base station devices 200 and perform wireless communication with other terminal devices, and are smartphones or tablet terminals, for example.

The reflection device 300 is a device that reflects radio waves transmitted from the base station devices 200 and the terminal devices 100, and transmits reflected waves. The reflection device 300 reflects the received radio waves, under the control of the base station device 200. The reflected waves includes notification information transmitted by the base station devices 200, for example. Also, the reflected waves include a communication signal that is transmitted and received in wireless communication between the base station devices 200 and the terminal devices 100, or a control signal.

The reflection device 300 is a reconfigurable intelligent surface (RIS), for example. An RIS is a reflector using metasurface. Metasurface is a material that realizes electromagnetic properties (dielectric constant, magnetic permeability, and the like) that do not exist in nature, having structures regarded as atoms or molecules and arranged in a reflection device row, the structures being smaller than the wavelength of radio waves. Using metasurface, the RIS can reflect each radio wave of a plurality of radio waves in a desired direction. Also, the RIS can adjust information included in the reflected waves, and can add and update predetermined information, for example.

The shielding object 400 is an object that blocks radio waves. As the shielding object 400 is present, a base station device 200 cannot directly transmit and receive radio waves (without passing through the reflection device 300) to and from a terminal device 100 located in a certain specific area (a non-communication area). To complement wireless communication of the terminal device 100 located in the non-communication area, the base station device 200 transmits reflected waves to the non-communication area, using the reflection device 300.

In FIG. 1, the terminal device 100-1 is located in a non-communication area in which direct wireless connection to the base station device 200-1 is not possible. The terminal device 100-1 wirelessly connects to the base station device 200-1, using reflected waves W1 reflected by the reflection device 300. After that, under the control of the base station device 200-1 (in accordance with an instruction), for example, the reflection device 300 adjusts the reflection angle (transmission angle) of the reflected waves as the terminal device 100-1 moves, and tracks the terminal device 100-1.

In the wireless communication system 10, the terminal device 100-2 receives waves reflected toward the terminal device 100-1, for example, and measures radio quality (reception power, noise, and the like). In a case where the radio quality satisfies the condition for performing wireless connection at the time of a handover or a communication start, the terminal device 100-2 might attempt wireless connection to the base station device 200-1, which is the transmission source of the reflected waves. Assuming such a case, the base station device 200-2 transmits information regarding the reflected waves received by the terminal device 100-2 to the base station device 200-1, and controls the reflection device 300 prior to a handover process or a wireless connection process. Thus, the wireless communication system 10 can avoid a failure in wireless connection or a handover by the terminal device 100-2.

Note that the number of base station devices 200 is two in FIG. 1, but may be three or larger. Further, the number of terminal devices 100 is two in FIG. 1, but may be one, three, or larger than three.

### <Example Configuration of a Base Station Device 200>

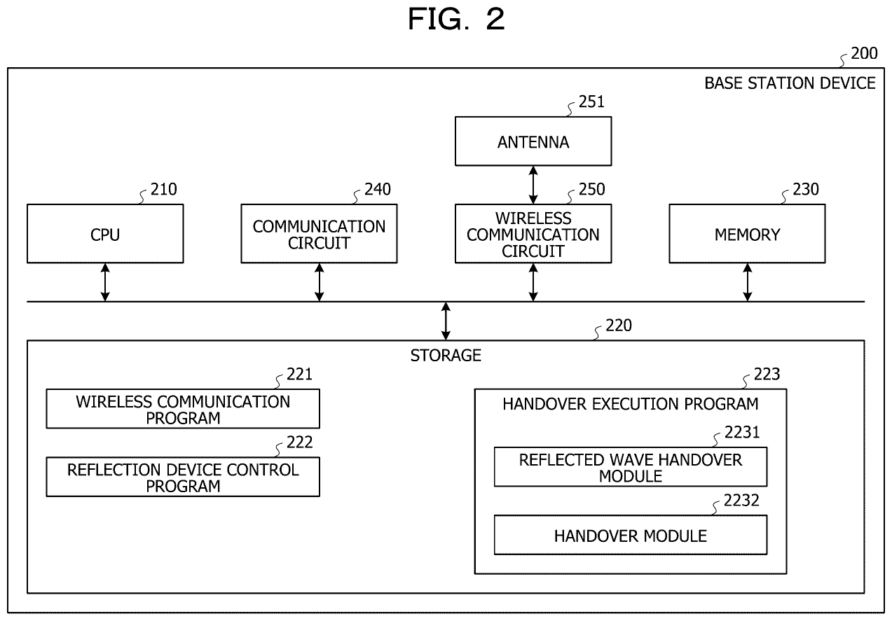

FIG. 2 is a diagram illustrating an example configuration of a base station device 200. The base station device 200 includes a central processing unit (CPU) 210, a storage 220, a memory 230, a communication circuit 240, a wireless communication circuit 250, and an antenna 251.

The storage 220 is an auxiliary storage device that stores programs and data, such as a flash memory, a hard disk drive (HDD), or a solid-state drive (SSD). The storage 220 stores a wireless communication program 221, a reflection device control program 222, and a handover execution program 223.

The memory 230 is an area into which a program stored in the storage 220 is loaded. Also, the memory 230 may also be used as an area into which a program stores data.

The communication circuit 240 is a device that communicates with another base station device 200 and the reflection device 300. The communication circuit 240 may be a wired communication circuit such as a network interface (NI) or a communication circuit compatible with wireless connection, for example.

The wireless communication circuit 250 is a device that performs wireless communication with a terminal device 100. The wireless communication circuit 250 connects wirelessly to the terminal device 100 via the reflection device 300 or directly to the terminal device 100, to perform wireless communication. The wireless communication circuit 250 has the antenna 251. The antenna 251 includes a directional antenna capable of controlling the direction of transmission/reception of radio waves, for example.

The CPU 210 is a processor that loads the programs stored in the storage 220 into the memory 230 and executes the loaded programs, to construct the respective components and realizes the respective processes.

The CPU 210 executes the wireless communication program 221, to perform a wireless communication process. The wireless communication process is a process of establishing wireless connection with the terminal device 100, and realizing communication being performed by the terminal device 100.

The CPU 210 executes the reflection device control program 222, to construct a control unit, a second control unit, and a reflection control unit, and perform a reflection device control process. The reflection device control process is a process of causing the reflection device 300 to perform reflection control. The base station device 200 instructs the reflection device 300 to transmit reflected waves to a specific terminal device 100. Further, the base station device 200 instructs the reflection device 300, regarding the reflection angle of the reflected waves, the transmission output, information added to the reflected waves, and the like.

The CPU 210 executes the handover execution program 223, to construct a reception unit, a second reception unit, a request receiving unit, a control unit, a second control unit, and a reflection control unit, and performs a handover execution process. The handover execution process is a process of executing a handover for the terminal device 100. The handover execution process includes a reflected wave handover process for the terminal device 100 that has received the reflected waves, and a handover process for the terminal device 100 that has received regular radio waves other than the reflected waves.

The CPU 210 executes a reflected wave handover module 2231 included in the handover execution program 223, to construct the reception unit, the second reception unit, the request receiving unit, the control unit, the second control unit, and the reflection control unit, and perform the reflected wave handover process. The reflected wave handover process is a process of executing a handover for the terminal device 100 that has received the reflected waves. In the reflected wave handover process, the base station device 200 transmits reflection control information received from the terminal device 100, to the base station device 200 that is the handover destination.

Further, the reflected wave handover process includes a process to be performed when a handover request including the reflection control information is received. When permitting a handover, the base station device 200 generates reflection control information for the terminal device 100 that is to execute the handover, based on the received reflection control information, and performs reflection control on the reflection device 300, using the reflection control information.

The CPU 210 executes a handover module 2232 included in the handover execution program 223, to construct the reception unit, the second reception unit, and the request receiving unit, and perform the handover process. The handover process is a process of executing a handover for the terminal device 100 that has received regular radio waves that are not reflected waves.

### <Example Configuration of a Terminal Device 100>

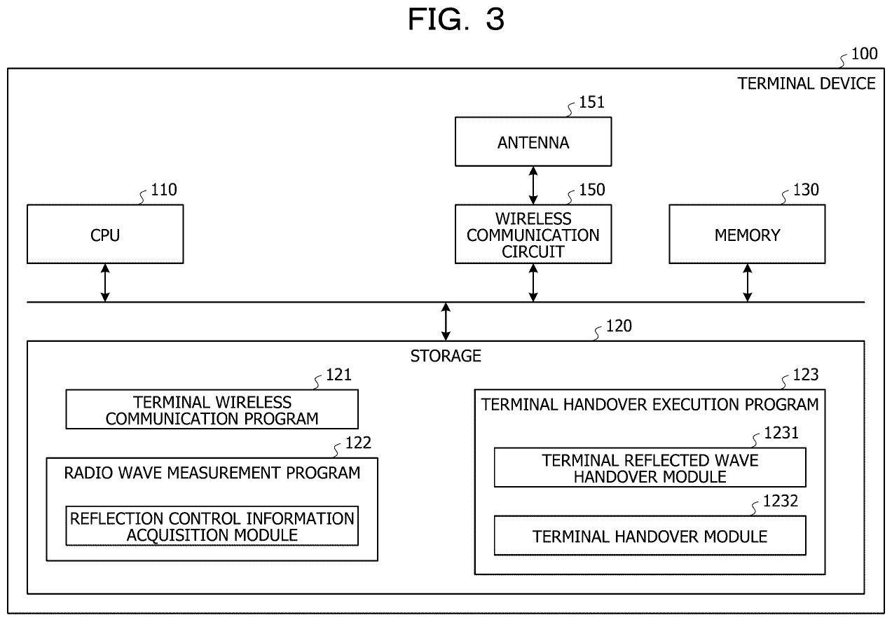

FIG. 3 is a diagram illustrating an example configuration of a terminal device 100. The terminal device 100 includes a CPU 110, a storage 120, a memory 130, a wireless communication circuit 150, and an antenna 151.

The storage 120 is an auxiliary storage device that stores programs and data, such as a flash memory, an HDD, or an SSD. The storage 120 stores a terminal wireless communication program 121, a radio wave measurement program 122, and a terminal handover execution program 123.

The memory 130 is an area into which a program stored in the storage 120 is loaded. Also, the memory 130 may be used as an area into which a program stores data.

The wireless communication circuit 150 is a device that performs wireless communication with the base station device 200. The wireless communication circuit 150 connects wirelessly to the base station device 200 via the reflection device 300 or directly to the base station device 200, to perform wireless communication. The wireless communication circuit 150 has the antenna 151. The antenna 151 includes a directional antenna capable of controlling the direction of transmission/reception of radio waves, for example.

The CPU 110 is a processor that loads the programs stored in the storage 120 into the memory 130 and executes the loaded programs, to construct the respective components and realize the respective processes.

The CPU 110 executes the terminal wireless communication program 121, to perform a terminal wireless communication process. The terminal wireless communication process is a process of wirelessly connecting to the base station device 200, and realizing wireless communication with another terminal device 100 and the base station device 200.

The CPU 110 executes the radio wave measurement program 122, to construct a measurement unit and perform a radio wave measurement process. The radio wave measurement process is a process of measuring radio waves that can be received by the terminal device 100, in response to a request from the base station device 200 or on a regular basis. In the radio wave measurement process, the terminal device 100 measures the radio quality (reception power, frequency band, noise, and the like) of received radio waves, and reports the radio quality to the base station device 200.

The CPU 110 executes the terminal handover execution program 123, to perform a terminal handover execution process. The terminal handover execution process is a process of receiving permission of a handover from the base station device 200, and executing a handover to the base station device 200 that is the movement destination. The terminal handover execution process includes a terminal reflected wave handover process of performing a handover to the base station device 200 that is the transmission source of the reflected waves by using the reflected waves, and a terminal handover process of performing a handover by using regular radio waves that are not reflected waves.

The CPU 110 executes a terminal reflected wave handover module 1231 included in the terminal handover execution program 123, to perform the terminal reflected wave handover process. The terminal reflected wave handover process is a process of executing a handover to the base station device 200 as the transmission source of the reflected waves, using the received reflected waves.

The CPU 110 executes a terminal handover module 1232 included in the terminal handover execution program 123, to perform the terminal handover process. The terminal handover process is a process of executing a handover, using regular radio waves that are not reflected waves. Alternatively, the terminal handover process may be a process in which the terminal device 100 executes a regular handover, without distinguishing reflected waves from regular radio waves.

### <Example Configuration of the Reflection Device 300>

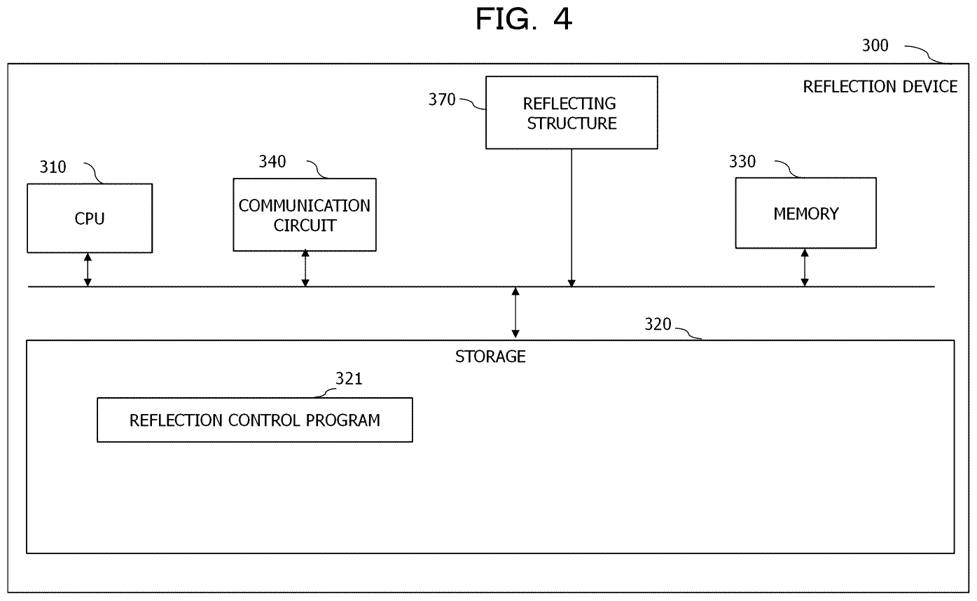

FIG. 4 is a diagram illustrating an example configuration of the reflection device 300. The reflection device 300 includes a CPU 310, a storage 320, a memory 330, a communication circuit 340, and a reflecting structure 370.

The storage 320 is an auxiliary storage device that stores programs and data, such as a flash memory, an HDD, or an SSD. The storage 320 stores a reflection control program 321.

The memory 330 is an area into which a program stored in the storage 320 is loaded. Further, the memory 330 may be used as an area into which a program stores data.

The communication circuit 340 is a device that performs communication with the base station device 200. The communication circuit 340 may be a wired communication circuit such as an NI or a communication circuit compatible with wireless connection, for example.

The reflecting structure 370 is an assembly of a plurality of structures that receive radio waves transmitted by the base station devices 200 and the terminal devices 100, and transmit the radio waves at a desired angle. The reflecting structure 370 can receive radio waves and transmit (reflect) radio waves in units of structures.

The CPU 310 is a processor that loads a program stored in the storage 320 into the memory 330, and executes the program, to construct the respective components and realize the respective processes.

The CPU 310 executes the reflection control program 321, to perform a reflection control process. The reflection control process is a process of controlling reflection of received radio waves. In the reflection control process, the reflection device 300 performs reflection control, in accordance with an instruction from a base station device 200. Also, the reflection device 300 performs reflection control so as to track a designated terminal device 100. Further, the reflection device 300 performs reflection control so that reflected waves reach a specific area (an area to which radio waves from the base station device 200 do not reach, for example). Furthermore, the reflection device 300 can adjust the angle, the frequency, the beam width, and the like of reflected waves. Further, the reflection device 300 may be capable of incorporating predetermined information into reflected waves or changing (updating) part of the information.

<Wireless Connection Process with Reflected Waves>

A wireless connection process with reflected waves is described.

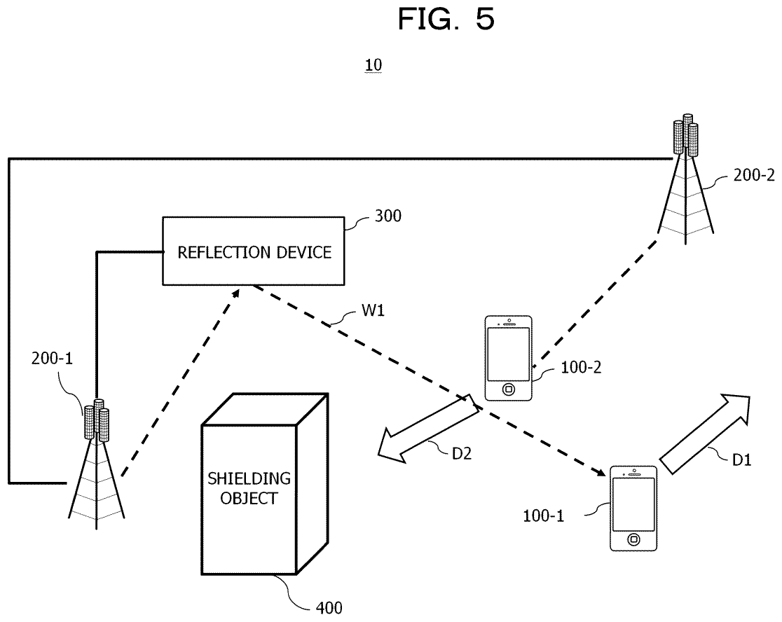

FIG. 5 is a diagram illustrating an example of a process in which the terminal device 100-2 performs a handover to the base station device 200-1. In FIG. 5, the terminal device 100-2 wirelessly connects to the base station device 200-2, and is performing wireless communication.

The terminal device 100-2 receives reflected waves W1 transmitted to the terminal device 100-1, and determines whether the reflected waves W1 satisfy the handover conditions.

On the other hand, the terminal device 100-1 wirelessly connects to the base station device 200-1. The reflection device 300 is controlled to track the movement of the terminal device 100-1 and transmit reflected waves, in accordance with an instruction from the base station device 200-1.

Therefore, in a case where the terminal device 100-1 moves in the direction of an arrow D1, for example, the reflected waves W1 also move in the direction of the arrow D1. At this point of time, when the terminal device 100-2 moves in the direction of an arrow D2, the terminal device 100-2 moves away from the reflected waves W1, and therefore, there is a possibility that a handover using the reflected waves W1 will fail.

To counter this in the wireless communication system 10, the base station device 200-1 controls the reflection device 300 prior to a handover process by the terminal device 100-2, and avoids a failure of the handover by the terminal device 100-2.

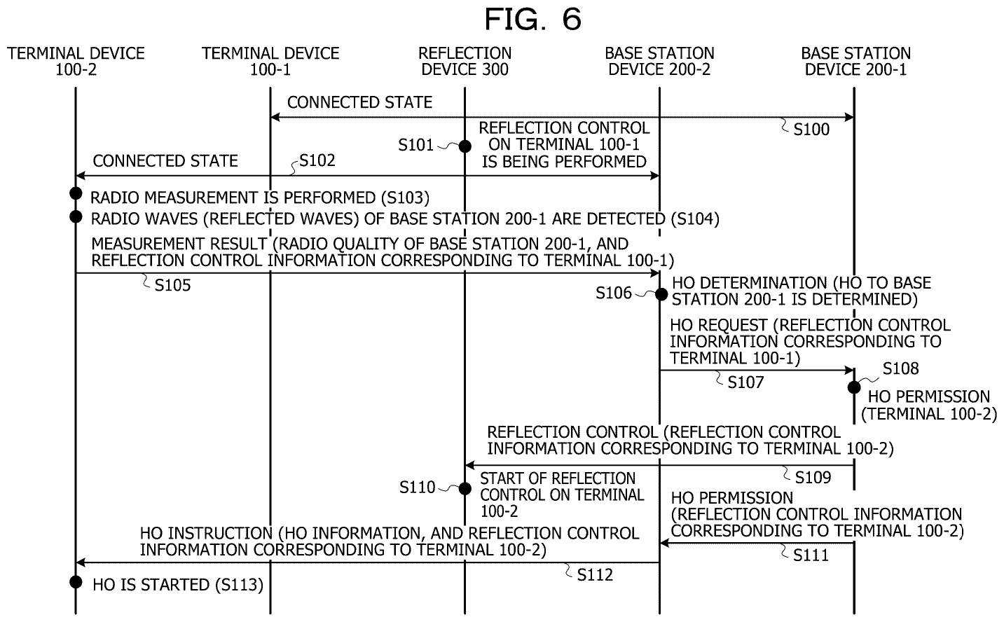

FIG. 6 is a diagram illustrating an example of a sequence in which the terminal device 100-2 performs a handover to the base station device 200-1. Note that, in the subsequent drawings, it is assumed that a terminal 100-1 corresponds to the terminal device 100-1, a terminal 100-2 corresponds to the terminal device 100-2, a base station 200-1 corresponds to the base station device 200-1, and a base station 200-2 corresponds to the base station device 200-2, respectively.

The terminal device 100-1 is in a connected state in which the terminal device 100-1 wirelessly connects to the base station device 200-1 (S100). The terminal device 100-1 connects to the base station device 200-1 via the reflection device 300.

The reflection device 300 is performing reflection control to control reflection from the terminal device 100-1 (S101). The reflection control is control to follow (track) the movement of the terminal device 100-1, to adjust the reflection angle of the reflected waves, for example.

Meanwhile, the terminal device 100-2 is in a connected state in which the terminal device 100-2 wirelessly connects to the base station device 200-2 (S102).

The terminal device 100-2 performs radio measurement (S103). The terminal device 100-2 performs, on a regular basis or an irregular basis, radio measurement to measure the quality (reception power, noise, and the like) of radio waves transmitted by the base station devices 200 in the vicinity.

In the radio measurement, the terminal device 100-2 detects the radio waves transmitted by the base station device 200-1 (S104). The radio waves of the base station device 200-1 detected by the terminal device 100-2 are reflected waves that have been transmitted by the reflection device 300 and are compatible with the terminal device 100-1. The reflected waves compatible with the terminal device 100-1 are radio waves for the terminal device 100-1 to transmit signals to be used in wireless communication, for example. Hereinafter, the reflected waves compatible with the terminal device 100-1 will be referred to as the reflected waves for the terminal device 100-1 in some cases.

The reflected waves include reflection control information (control information), for example. The reflection control information is information indicating that the waves are reflected waves. The reflection control information includes the identifier (identification information) of the terminal device 100 being tracked, for example. As the reflection control information includes the identifier of the terminal device, it is possible to determine which terminal device 100 the reflected waves are transmitted to be used for communication.

Further, the reflection control information may include a flag indicating that the reflection is reflection via the reflection device 300. Furthermore, the reflection control information may include information regarding reflection in the reflection device 300. The information regarding reflection includes the identifier of the reflecting structure that is performing the reflection, the reflection angle, the beam transmission direction, the frequency of the reflected waves, the beam width, and the like, for example. Further, in a case where there is a plurality of reflection devices 300, the reflection control information may include the identifiers of the reflection devices 300.

The reflection control information is included in notification information, for example. For example, a base station device 200 may set the reflection control information as the notification information. The base station device 200 transmits both notification information for a reflected waves, and notification information for the terminal devices 100 that perform wireless communication without using reflected waves, for example. The notification information for reflected waves is transmitted in the direction of reflection device 300, for example.

Alternatively, the reflection device 300 may set the reflection control information as the notification information, for example. The reflection device 300 adds the reflection control information to the notification information received from the base station device 200, and reflects the notification information at a predetermined angle, for example.

Alternatively, the reflection control information may be included not in the notification information but in a signal for communication or control.

The terminal device 100-2 transmits (reports), to the base station device 200-2, a measurement result including the radio quality of the radio waves of the base station device 200-1 and the reflection control information (control information) about the received reflected waves (S105). The reflection control information includes the identifier of the terminal device 100-1, and is the reflection control information corresponding to the terminal device 100-1. The measurement result is included in a measurement report, for example. Alternatively, the measurement result is included in a handover request, for example.

Receiving the measurement result, the base station device 200-2 determines whether the terminal device 100-2 is to perform a handover, based on the reception quality (S106). Then, the base station device 200-2 then determines that the terminal device 100-2 is to perform a handover to the base station device 200-1 (S106).

The base station device 200-2 transmits, to the base station device 200-1, a handover request for requesting the terminal device 100-2 to perform a handover (S107). The handover request includes the reflection control information that has been received by the terminal device 100-2 and corresponds to the terminal device 100-1.

The base station device 200-1 permits a handover by the terminal device 100-2, in response to the received handover request (S108). After permitting the handover, the base station device 200-1 starts reflection control on the reflection device 300, using the reflection control information corresponding to the terminal device 100-2 (S109). The reflection control information corresponding to the terminal device 100-2 includes the identifier of the terminal device 100-2, for example. The reflection control is control to follow (track) the movement of the terminal device 100-2, to adjust the reflection angle of the reflected waves, for example.

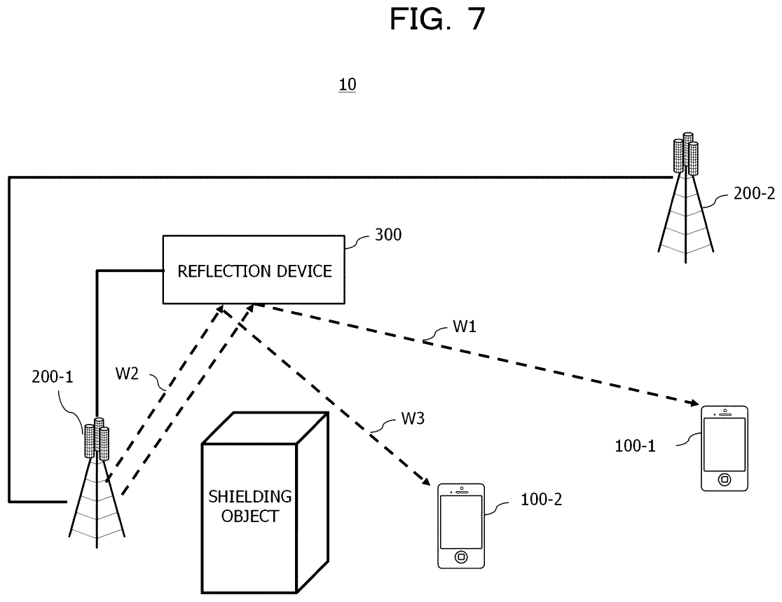

FIG. 7 is a diagram illustrating an example of the reflected waves at the time of execution of reflection control on the terminal device 100-2. The base station device 200 transmits, to the reflection device 300, radio waves W2 for the terminal device 100-2. The radio waves W2 include the reflection control information corresponding to the terminal device 100-2.

Receiving the radio waves W2, the reflection device 300 transmits reflected waves W3 (the second reflected wave). For example, the reflected waves W3 are transmitted to the position at which the terminal device 100-2 has received the reflected waves for the terminal device 100-1. The reflected waves W3 include the reflection control information (the second control information) corresponding to the terminal device 100-2.

In this case, the reflection device 300 (or the base station device 200-1) transmits the reflected waves to the position at which the terminal device 100-2 has received the reflected waves for the terminal device 100-1, at least until the handover is completed. The reflection device 300 (or the base station device 200-1) may start tracking the terminal device 100-2, after the terminal device 100-2 transitions into communication with the base station device 200-1.

Further, the terminal device 100-2 may be tracked before the transition into communication with the base station device 200-1 (in a wireless connection execution state), for example, and the reflected waves W3 may then be transmitted in the direction in which the terminal device 100-2 is located.

Note that the reflection control information may be added to the reflected waves by the reflection device 300. In this case, the radio waves transmitted by the base station device 200-1 do not include the reflection control information. The reflection device 300 receives the radio waves that do not include the reflection control information from the base station device 200-1, and transmits, at the respective reflection angles (in the respective directions), the reflected waves W1 to which the reflection control information corresponding to the terminal device 100-1 has been added, and the reflected waves W3 to which the reflection control information corresponding to the terminal device 100-2 has been added.

Referring back to the sequence in FIG. 6, the reflection device 300 responds to the reflection control by the base station device 200-1, and starts reflection control on the terminal device 100-2 (S110).

Meanwhile, the base station device 200-1 transmits, to the base station device 200-2, a handover permission to permit a handover (S111). The reflection control information corresponding to the terminal device 100-2 is included in the handover permission.

Receiving the handover permission, the base station device 200-2 transmits, to the terminal device 100-2, a handover instruction to instruct the terminal device 100-2 to perform a handover (S112). The handover instruction includes handover information related to the handover and the reflection control information corresponding to the terminal device 100-2.

Receiving the handover instruction, the terminal device 100-2 starts a handover to the base station device 200-1 (S113). In the handover process, the terminal device 100-2 may adjust the direction of radio wave reception in accordance with the angle of reflection included in the reflection control information corresponding to the terminal device 100-2, or search for the reflection including the identifier of the terminal device 100-2, for example.

In the first embodiment, prior to the handover process by the terminal device 100-2, the reflection device 300 starts reflection control for the terminal device 100-2. Thus, even if the reflected waves move with the movement of the terminal device 100-1, the terminal device 100-2 can receive the reflection for the terminal device 100-2, and failed handovers decrease.

### Second Embodiment

Next, a second embodiment is described. In the first embodiment, the reflection device 300 is controlled by the base station device 200-1. In the second embodiment, it is assumed that the reflection device 300 can be controlled by both the base station device 200-1 and the base station device 200-2. The base station device 200-2 controls the reflection device 300 prior to a handover request.

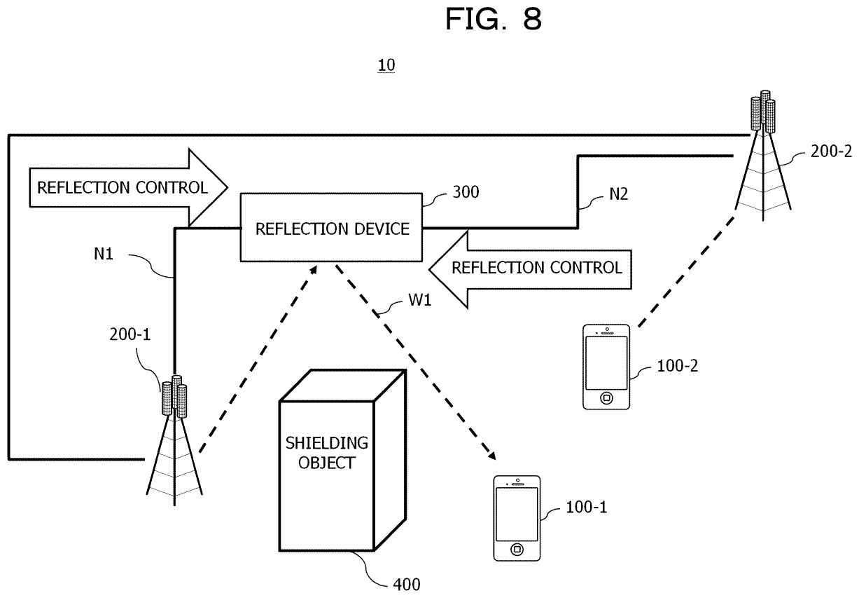

FIG. 8 is a diagram illustrating an example configuration of a wireless communication system 10. In the second embodiment, the reflection device 300 is subjected to reflection control from the base station device 200-1 via a network N1. Also, the reflection device 300 is subjected to reflection control from the base station device 200-2 via a network N2. The reflection device 300 may notify the other base station device 200 of the contents of the reflection control from one base station device 200, for example. As a result, the base station devices 200-1 and -2 can share the contents of the reflection control.

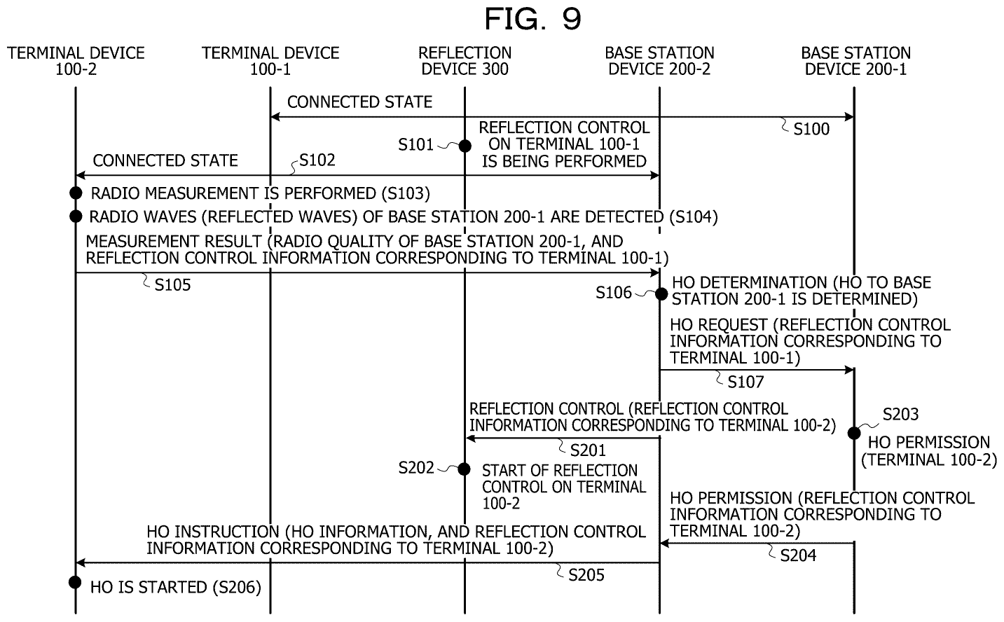

FIG. 9 is a diagram illustrating an example of a sequence in which the terminal device 100-2 performs a handover to the base station device 200-1. Processes S101 to S107 are similar to those in the sequence in FIG. 6. Note that, when controlling the reflection device 300, the base station device 200-2 may acquire reflection control information from the reflection device 300.

The base station device 200-2 starts reflection control on the reflection device 300, using the reflection control information corresponding to the terminal device 100-2 (S201). The reflection control information corresponding to the terminal device 100-2 includes the identifier of the terminal device 100-2, for example. The reflection device 300 responds to the reflection control by the base station device 200-2, and starts reflection control on the terminal device 100-2 (S202).

Meanwhile, the base station device 200-1 permits a handover by the terminal device 100-2, in response to a received handover request (S203). Then, the base station device 200-1 then transmits, to the base station device 200-2, a handover permission to permit a handover (S204). The handover permission includes the reflection control information corresponding to the terminal device 100-2.

Receiving the handover permission, the base station device 200-2 transmits, to the terminal device 100-2, a handover instruction to instruct the terminal device 100-2 to perform a handover (S205). The handover instruction includes handover information related to the handover and the reflection control information corresponding to the terminal device 100-2.

Receiving the handover instruction, the terminal device 100-2 starts a handover to the base station device 200-1 (S206).

Note that, in a case where the handover is not permitted, the base station device 200-2 transmits an instruction to the reflection device 300 to stop the reflection control on the terminal device 100-2.

In the second embodiment, prior to the handover process by the terminal device 100-2, the reflection device 300 can start reflection control for the terminal device 100-2 even before the handover is permitted. Thus, even if the reflected waves move with the movement of the terminal device 100-1, the terminal device 100-2 can receive the reflection for the terminal device 100-2, and failed handovers decrease more significantly.

### OTHER EMBODIMENTS

In the first and second embodiments, the terminal device 100-2 acquires reflection control information from reflected waves, adds the reflection control information to a measurement result, and transmits the measurement result to the base station device 200-2. However, the terminal device 100-2 may not transmit the reflection control information to the base station device 200-2. In this case, the base station device 200-2 determines that the terminal device 100-2 is receiving the reflected waves of the base station device 200-1, from positional information about the terminal device 100-2, for example. Then, the base station device 200-2 may then acquire the reflection control information regarding the reflected waves being transmitted to the vicinity of the position of the terminal device 100-2, from the reflection device 300 transmitting the reflected waves. As a result, the terminal device 100-2 can perform a similar process, regardless of whether the received radio waves are reflected waves.

Furthermore, the respective requirements described in the first, second, and other embodiments may be combined.

All examples and conditional language provided herein are intended for the pedagogical purposes of aiding the reader in understanding the disclosure and the concepts contributed by the inventor to further the art, and are not to be construed as limitations to such specifically recited examples and conditions, nor does the organization of such examples in the specification relate to a showing of the superiority and inferiority of the disclosure. Although one or more embodiments of the present disclosure have been described in detail, it should be understood that the various changes, substitutions, and alterations could be made hereto without departing from the spirit and scope of the disclosure.

What is claimed is:

1. A first base station device in a wireless communication system that includes:
the first base station device configured to wirelessly connect to a first terminal device; and
a second base station device configured to wirelessly connect to the first terminal device via a reflection device, in which the reflection device is controlled by the second base station device, to reflect a radio wave transmitted by the second base station device, and transmit a reflected wave,
the first base station device comprising:
a reception circuit configured to receive, from the first terminal device, a measurement result indicating radio quality of the reflected wave measured by the first terminal device, and control information obtained from the reflected wave by the first terminal; and
a control circuit configured to transmit the control information to the second base station device, when the first terminal device performs a handover to the second base station device.

2. The first base station device according to claim 1, wherein,
when permitting the handover by the first terminal device, the second base station device generates, based on the control information, second control information to be used for controlling a second reflected wave to be used in the handover to the second base station device by the first terminal device, and controls the reflection device to transmit the second reflected wave based on the second control information.

3. The first base station device according to claim 2, wherein
the control circuit is further configured to receive the second control information from the second base station device, and transmit a handover permission that includes the second control information to the first terminal device.

4. The first base station device according to claim 2, wherein
the second control information includes first identification information about the first terminal device.

5. The first base station device according to claim 4, wherein
the control information includes information regarding a reflection angle of the reflected wave, and
the second control information includes information regarding a reflection angle of the second reflected wave.

6. A first base station device in a wireless communication system that includes:
the first base station device configured to wirelessly connect to a first terminal device; and
a second base station device configured to wirelessly connect to the first terminal device via a reflection device,
in which the reflection device is controlled by the first base station device and the second base station device, to reflect a radio wave transmitted by the second base station device, and transmit a reflected wave,
the first base station device comprising:
a second reception circuit configured to receive, from the first terminal device, a result of measurement of radio quality of the reflected wave measured by the first terminal device, and control information about the reflected wave, which is included in the reflected wave; and
a second control circuit configured to generate, when the first terminal device performs a handover to the second base station device, based on the control information, second control information to be used for controlling a second reflected wave to be used in the handover to the second base station device by the first terminal device, and controls the reflection device to transmit the second reflected wave based on the second control information.

7. A second base station device in a wireless communication system that includes:
a first base station device configured to wirelessly connect to a first terminal device; and
the second base station device configured to wirelessly connect to the first terminal device via a reflection device,
in which the reflection device is controlled by the second base station device, to reflect a radio wave transmitted by the second base station device, and transmit a reflected wave,
the second base station device comprising:
a request receiving circuit configured to receive control information about the reflected wave from the first base station device, the first base station device being configured to receive, from the first terminal device, a measurement result indicating radio quality of the reflected wave measured by the first terminal device and the control information included in the reflected wave and obtained from the reflected wave by the first terminal device, the first base station device being configured to transmit the control information to the second base station device when the first terminal device performs a handover to the second base station device; and
a reflection control circuit configured to
generate, in accordance with the control information received from the first base station device, second control information to be used for controlling a second reflected wave to be used in the handover to the second base station device by the first terminal device, and
control the reflection device to transmit the second reflected wave based on the second control information.

8. The second base station device according to claim 7, wherein
the reflection control circuit is configured to transmit a handover permission that includes the second control information, to the first base station device.

9. A reflection control method in a first base station device in a wireless communication system that includes:
the first base station device configured to wirelessly connect to a first terminal device; and
a second base station device configured to wirelessly connect to a second terminal device via a reflection device,
in which the reflection device is controlled by the first base station device and the second base station device, to reflect a radio wave transmitted by the second base station device to the second terminal device, and transmit a reflected wave toward the second terminal device,
the reflection control method comprising:
receiving, from the first terminal device, a result of measurement of radio quality of the reflected wave measured by the first terminal device; and
when the result of measurement satisfies a condition for the first terminal device to perform a handover to the second base station device, incorporating control information included in the reflected wave, into a handover request and transmitting the handover request including the control information to the second base station device.

10. A wireless communication system comprising:
a first base station device configured to wirelessly connect to a first terminal device; and
a second base station device configured to wirelessly connect to a second terminal device via a reflection device,
wherein
the reflection device is controlled by the second base station device, to reflect a radio wave transmitted by the second base station device to the second terminal device, and transmit a reflected wave toward the second terminal device,
the first terminal device is configured to receive the reflected wave, and transmit, to the first base station device, a result of measurement of radio quality of the reflected wave,
the first base station device is configured to incorporate, when the result of measurement satisfies a condition for the first terminal device to perform a handover to the second base station device, control information included in the reflected wave, into a handover request and transmit the handover request to the second base station device,
the second base station device is configured to
generate, when permitting the first terminal device to perform the handover to the second base station device, based on the control information, second control information to be used for controlling a second reflected wave to be used in the handover to the second base station device by the first terminal device, and
control the reflection device to transmit the second reflected wave based on the second control information, and
the reflection device is configured to transmit, in accordance with the control, the second reflected wave to the first terminal device, based on the second control information.
